(19) United States
(12) Patent Application Publication
(10) Pub. No.: US 2021/0121993 A1
(43) Pub. Date: Apr. 29, 2021

(54) DEVICE AND METHOD FOR PLASMA CUTTING OF WORK PIECES

(71) Applicant: Linde Aktiengesellschaft, Munchen (DE)

(72) Inventor: Nakhleh A. HUSSARY, Ismaning (DE)

(21) Appl. No.: 16/635,650

(22) PCT Filed: Jul. 9, 2018
(86) PCT No.: PCT/EP2018/025187

§ 371 Date: Jan. 31, 2020

(30) Foreign Application Priority Data
Jul. 31, 2017 (GB) 1712303.5

(51) Int. Cl. B23K 37/00; B23K 9/16; B23K 10/00

(52) U.S. Cl. CPC B23K 37/003; B23K 10/00; B23K 9/164

(57) ABSTRACT

The present invention relates to a device for plasma cutting, comprising a cutting torch (100) provided with an electrode (120), which is coaxially surrounded by a nozzle (110), thereby defining a passage (112) for passing of a plasma gas between electrode and nozzle, wherein the nozzle is coaxially surrounded by a shielding cap (122), thereby defining a passage (114) for passing of a shielding flow between nozzle and shielding cap, the device further comprising an annular member (200) coaxially surrounding the cutting torch (100) configured and adapted to provide a further curtain flow coaxially surrounding the shielding flow through passage (250a and 250b) wherein annular member (200) is configured and adapted for use of CO₂-snow or a mixture containing CO₂-snow as shielding flow.

### TECHNICAL FIELD

The invention relates to a device and method for plasma cutting of work pieces.

### BACKGROUND

A plasma is a super-heated, electrically conductive fluid composed of positive and negative ions, electrons and excited and neutral atoms and molecules. Different gases/fluids can be used as the plasma gases/fluids. These gases/fluids dissociate and ionize by means of the electrical energy deposited into the plasma by the electric arc.

The plasma arc cutting process, also known as plasma cutting or arc cutting, a well-known manufacturing process, is commonly used for cutting, marking and gouging of conductive materials. Plasma cutting uses a highly constricted arc with a high energy density and high pressure to heat, melt and blow the resulting molten material off a workpiece to be cut. The process typically uses a plasma forming gas and a shielding fluid. The shielding fluid can be a gas or a liquid that is injected around a main plasma arc. In earlier developments, gas was commonly used as a shield, and subsequently liquid water was also used within the first few years of the invention of the process.

In plasma cutting, a cutting torch is utilized, which typically comprises an electrode, a nozzle, plasma gas distributor, a shield gas/fluid distributor and a shield cap. In the following, such a shield cap is sometimes simply referred to as a shield. Herein, the nozzle coaxially surrounds the electrode, defining a passage for passing of a plasma forming gas therebetween, and the shield cap coaxially surrounds the nozzle, defining a passage for passing of a shielding gas or fluid therebetween. The nozzle is provided with passages for a plasma gas and the shield cap is provided with passages for a shielding fluid. Within the nozzle, a plasma arc is generated between the nozzle and the electrode during the piloting phase. As the arc exits the nozzle, under the action of the plasma forming gas flow, the power supply senses the extension of the arc towards the work piece and disconnects the nozzle from the circuit forcing the arc to fully transfer to the work piece. The parameters of a plasma arc can be influenced by the design of the nozzle, from which the plasma arc is ejected, and the electrode within the nozzle, shield nozzle, and both the gas/fluid distribution members for both the plasma and the shield lines.

It is the goal of plasma cutting systems to provide a plasma cutting arc that achieves the highest cutting speed at the highest cutting quality and therefore at the best cost base. Quality is, in part, defined as the lack of bottom dross (solidified metal hanging on the lower edge of the cut face), angularity of the cut surface as well as its smoothness. To achieve such goals, the plasma cutting arc needs to provide high energy density at a very localized footprint during cutting. The stability of the arc must be maintained to avoid any striations and imperfections of the surface of the cut and provides controlled repeatability. Therefore, the plasma cutting arcs tend to be highly constricted. Traditionally, the constriction is achieved through a number of methods known in the prior art literature. Four main methods are typically used, (1) wall constriction and stabilization, (2) plasma gas swirl flow constriction and stabilization, (3) shield flow constriction and stabilization and (4) magnetic constriction and stabilization. There are limitations to all the above methods. For example, a small diameter nozzle that provides wall constriction and stabilization is limited by the high arc heat load (the smaller the diameter at a given current/power level the high the heat load will be) and the nozzle material selection (typically copper or high thermal conductivity metals) that allows the removal of such heat. Similarly, a properly established plasma forming gas swirl enhances such constriction and stabilization when combined in a correct way with the selected plasma gas nozzle orifice design. Furthermore, properly injecting the correct amount of shield flow (gas or liquid, swirled or non-swirled) dramatically improves the constriction and stability of the arc. Magnetic constriction, while theoretically possible, tends to require large magnetic field values, on the order of a Tesla, rendering it industrially impractical for constriction purposes. The injection shield flow improves the arc constriction by properly shaping the boundary layer between the arc and the outside atmosphere. As the shield flow is injected around the arc, it cools the fringes of the arc effectively decreasing its foot print. The cooled arc fringes no longer possess the high temperature required to carry the electrical current. The effective decrease of the current carrying cross section, therefore, forces an increase in temperature of the plasma core, thereby increasing the electrical conductivity of the plasma to compensate for such cross section reduction and maintain the constant current provided by the power source. The shield flow also provides a buffer against the atmosphere and preserves the chemistry of the plasma flow, minimizes or enhances the flow velocity of the arc and the overall flow field.

A typical solution that has been used in plasma cutting is the use of water as shielding fluid, which is injected around the main plasma arc as it exits the nozzle of the cutting torch. Water is introduced around the arc tangentially, radially or in an angular vector to further constrict the arc. The amount of water used varies with the particular design. In some applications, so called water mufflers are used. These are components that are used to introduce water around the plasma torches. Typically, these are provided as additional components that are not designed as part of the torch.

Plasma cutting is an intense source of pollutants, these pollutants including metal particulates and gases (e.g. ozone, NO, NO₂, . . . ), electromagnetic radiation (UV light) and sound emissions. In the prior art, a number of technologies have been introduced to reduce these sources of pollutants. Prior art methods include underwater cutting, where the torch and/or the work piece are fully or partially submerged in water during the cutting process. Furthermore, water tables, in which the water level is at or just below the bottom surface of a plate being cut, and down draft tables, in which the ambient air is sucked through the table and passed through filters, have been used. These technologies have drawbacks. For example, under water cutting or water tables produce waste water that has to be properly collected, stored and disposed of, which leads to high operating costs. Underwater cutting and water table cutting produce lower quality cuts and reduce the consumable life of the plasma cutting torches, especially of torch components such as electrodes, nozzles and shield caps.

Water used as shielding fluid, for example provided by a water muffler, also gets contaminated and requires collection and disposition. Also, water leaves marks on the work piece or plate, that are especially undesirable for aluminium and stainless steel, so that this leads to the requirement of further cleaning, and can also cause rusting on mild steel.

Down draft tables tend to be the most useful for dust collection, but in facilities where the plate being cut is very large, the design of the table becomes critical to be able to extract all of the fumes. Furthermore, water impacting the filters of down draft tables can cause damage to the filters, thereby reducing their effectiveness and life. Down draft tables are not able to reduce noise or block UV arc radiation.

It is the object of the invention to provide a plasma cutting device, with which the disadvantages outlined above can be minimized or prevented.

### DISCLOSURE OF THE INVENTION

This object is achieved by a device comprising the features of independent claim 1 and corresponding method according to claim 12.

According to the invention there is suggested a device for plasma cutting a work piece, comprising a cutting torch configured and adapted to generate a plasma arc between itself and the workpiece, the cutting tool being provided with an electrode, which is coaxially surrounded by a nozzle, thereby defining a passage for passing of a plasma gas between electrode and nozzle, wherein the nozzle is coaxially surrounded by a shielding cap , thereby defining a passage for passing of a shielding flow between nozzle and shielding cap, the device further comprising an annular member coaxially surrounding the cutting torch configured and adapted to provide a further curtain flow coaxially surrounding the plasma cutting torch, wherein annular member is configured and adapted for use of CO₂-snow or a mixture containing CO₂-snow as curtain flow. The annular member providing such a curtain flow also acts as a muffler, and is therefore sometimes also referred to as a muffler in the following.

The invention can improve on prior art curtain flow liquids (typically water) by injecting CO₂ snow. Hereby there is provided enhanced containment of the plasma cutting process emissions including particulate, gaseous, electromagnetic and noise. The CO₂ snow sublimes and it leaves no liquid that flows over the surface of the metal to be cut.

According to a preferred embodiment, the annular member (CO₂ muffler) is configured and adapted to be provided with CO₂-snow and to form the curtain flow using this provided CO₂-snow. Hereby, the annular member can be provided in a very compact form, as it does not comprise means for generating CO₂-snow.

It is also advantageously possible to configure and adapt the annular member to be provided with liquid or gaseous CO₂ from an external source, generate CO₂-snow and form the curtain CO₂ snow flow using the generated CO₂-snow.

Advantageously, the annular member is configured and adapted to provide a curtain flow comprising CO₂-snow with or without a carrier gas. By the choice of a suitable carrier gas, for example a suitably compressed carrier gas, the momentum of the CO₂-snow particles or flakes can be increased, leading to enhanced shielding effects. By providing CO₂-snow without a carrier gas, an especially dense and concentrated flow of CO₂-snow is achievable. Using carrier gases or fluids also provides an effective way of injecting a curtain flow in a desired amount and direction. On the other hand, providing a curtain flow without a carrier gas can be advantageous for certain applications.

According to a preferred embodiment, the annular member is configured and adapted to provide a shielding flow which is directed in a direction forming a converging or a diverging angle relative to a main extension direction of the plasma arc generated between the cutting torch and the work piece. This ensures a particularly effective curtain around the plasma arc with minimum, if any, disturbance of the plasma arc.

The annular member can also advantageously be configured and adapted to provide a curtain flow which is directed in a direction parallel or essentially parallel to a main extension direction of the plasma arc generated between the cutting torch and the work piece.

The annular member can also be configured and adapted to provide a curtain flow with a rotational component defining a rotational movement about a main extension direction of the plasma arc generated between the cutting torch and the work piece.

According to a preferred embodiment, the annular member is configured and adapted to provide the curtain flow as a continuous annular curtain. This can, for example, be achieved by providing an essentially annular opening or nozzle in the annular member.

According to a further advantageous embodiment, the annular member is configured and adapted to provide the curtain flow in form of a set of annularly arranged jets provided around the circumference of the annular member. To achieve this, advantageously a multitude of nozzles is provided around the circumference of the annular member, the arrangement of the nozzles defining a circle.

It is noted that the term “curtain flow” as used herein is meant to comprise any flow of material comprising solid and/or fluid, i.e. liquid and/or gaseous, components. The term “mixture containing CO₂-snow” as used herein is thus to be understood as comprising mixtures of CO₂-snow with any expediently chosen gases and/or liquids and/or solids.

The CO₂-snow thus ejected from the annular member around the cutting torch and thus around the plasma arc acts as a curtain to immediately cool, condense and nucleate any metallic fume generated on the work piece into particulates, preventing an uncollected escape. Furthermore, it effectively reduces noise levels generated by the process by acting as a damping barrier to the noise generated by the plasma arc. Also, it absorbs UV radiation generated in the process and prevents the formation of ozone further away from the arc zone along the radiation path. CO₂-snow acting as a curtain flow also cools the outside of the torch during cutting or piercing of thick material work pieces and during higher current operation, whereby the life of a plasma cutting torch. Also, it effectively cools thinner work pieces such as thin plates, thereby reducing warpage and thus eliminating complex procedures of nesting various cutting paths across the length and width of the work piece, which, in prior art applications, can increase cutting time and reduce the process throughput.

In addition to the various advantageous possibilities of varying the curtain flow provided by the annular member as described above, it is also possible to vary the shielding flow provided by the cutting torch, i.e. through the passage for passing shielding flow between the nozzle and the shielding cap of the cutting torch (referred to as cutting torch shielding flow in the following). As briefly explained above, the curtain flow provided by the annular member concentrically surrounds this shielding flow provided by the cutting torch itself.

This cutting torch shielding flow can be provided in a flow path which is split into a first central flow component provided directly around the arc and at least one second coaxial flow component provided coaxially around the central flow component. Each flow component can provide an effective curtain around the plasma arc. The central flow component is especially provided to constrict the plasma arc and enhance the cutting process.

Advantageously, the first flow component of the cutting torch shielding flow and the second flow component of the shielding flow are directed essentially in a direction parallel to a main extension direction of the plasma arc between the cutting torch and the work piece.

It is also possible to provide the first and/or the second flow components of the cutting torch shielding flow directed in a direction forming a converging or a diverging angle relative to the main extension direction of the plasma arc. For certain designs, an diverging angle helps in protecting the torch during the piercing which causes metal blowback during the piercing process. Similarly, a converging angle can also help in this respect. The outer component of the flow, aside from protecting the torching during the piercing phase and the cutting phase of the process, also acts as a built-in “CO₂ muffler” to reduce overall emissions, i.e. electromagnetic radiation including UV (causing ozone generation) NOx, particulate, noise, etc.

It is also possible to provide a cutting torch shielding flow or at least one of the first and second flow components of a cutting torch shielding flow directed towards the arc in a direction perpendicular or essentially perpendicular to the main extension direction of the arc.

It is also advantageous to provide the cutting torch shielding flow with a rotational component defining a rotational movement about the main extension direction of the plasma arc. This further improves the constriction of the plasma's arc and therefore, improves the cuttings speed and quality.

It is especially possible to combine different flow directions provided by the cutting torch shielding flow and the annular member curtain flow. For example, both flows can be provided in a converging angle or a diverging angle or parallel to the main extension direction of the plasma arc. Also, one of the flows can be provided in a converging angle, while the other flow is provided in a diverging angle or parallel to the main extension direction of the plasma arc.

Obviously, the cutting torch shielding flow can be provided as a shielding flow not comprising
CO₂-snow. The method of the present invention for plasma cutting a work piece comprises the following steps:
providing a cutting torch configured and adapted to generate a plasma arc between itself and the work piece,
providing a shielding flow to coaxially surrounding the plasma arc, and
providing a curtain flow coaxially surrounding the shielding flow, wherein the curtain flow comprises CO2-snow or a mixture containing CO2-snow.

Using CO2-snow in connection with the curtain flow is especially advantages in capturing particulate flumes emitted from the plasma during the cutting process. It is also advantages in capturing electromagnetic radiation emitted from the plasma during the cutting process. It is also especially advantages in capturing sound emissions emitted from the plasma during the cutting process. It is also advantages in capturing gases emissions emitted during the plasma cutting process.

Preferred embodiments of the invention will now be described with reference to the figures.

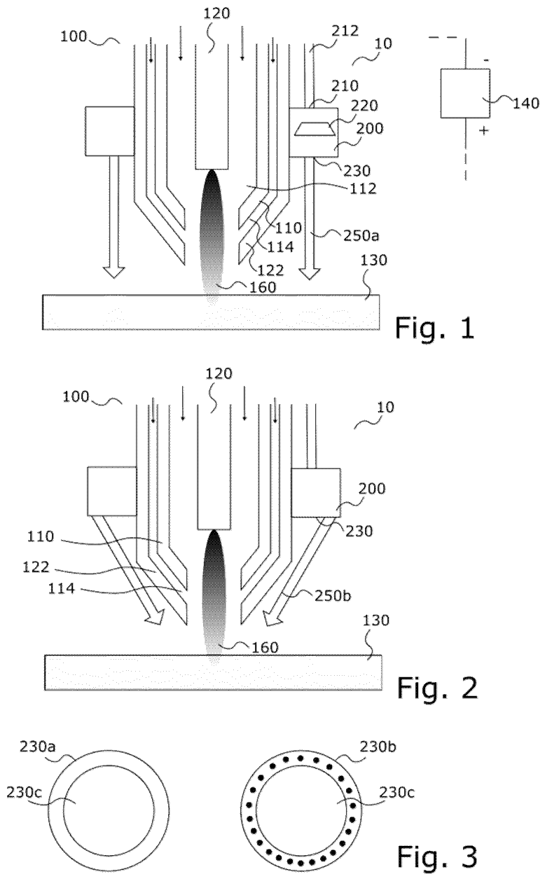

FIG. 1 shows a schematic side sectional view of a device for plasma cutting according to a first embodiment of the invention,

FIG. 2 a further schematic side sectional view of a device for plasma cutting according to a second embodiment of the invention, and

FIG. 3 shows schematic front views of an annular member as used in preferred embodiments of the device according to the invention.

In FIG. 1, a schematic side sectional view of a preferred embodiment of a device for plasma cutting a work piece is shown and generally designated by reference numeral 10. Device 10 comprises a cutting torch 100 and an annular member coaxially surrounding the cutting torch, also referred to as a muffler. The torch is generally designated 100, the annular member 200.

The cutting torch 100 comprises an electrode (cathode 120) coaxially surrounded by a nozzle 110. Electrode 120 and nozzle 110 defines a central passage 112 for passing of a plasma gas around electrode 120, i.e. between electrode 120 and nozzle 110. Coaxially surrounding nozzle 110 there is provided a shield 122, defining a passage 114 for a shielding flow between nozzle 110 and shield 122. The cutting torch 100 is arranged above a work piece 130 to be cut, the work piece acts as an anode during plasma cutting.

As is well-known in the art, an electrical cutting current flows from a schematically shown current source 140 to the plasma cutting torch 110 via electrode 120, a plasma arc 160 constricted by the nozzle 110 to the work piece 130 and back to the current source 140 (only shown in FIG. 1). As is also well-known in the art, this arrangement leads to formation of plasma cutting arc 160 between the electrode 120 and the work piece 130. The cutting arc 160 defines a main extension direction along the shortest line between the electrode 120 and the work piece 130.

Annular member 200 coaxially surrounds cutting torch 100. It can be provided as an add-on-extension for any plasma cutting torch, i.e. any kind of cutting torch can be retro-fitted with such an annular member. Annular member 200 comprises an inlet port 210 for an inlet path 212, via which CO₂ feed in liquid form and, optionally, a suitable compressed carrier gas, such as nitrogen, oxygen, air, argon, etc. or a mixture thereof, is introduced into the annular member. Within the annular member 200, there is provided a (schematically shown) CO₂-snow generator 220 for generating CO₂-snow by expanding the CO₂ feed. CO₂ snow thus generated is ejected via an outlet port 230, i.e. injected towards the working piece 130, thus defining an outlet path a shielding flow 250a comprising i.e. injected generated CO₂-snow. The compressed carrier gas acts to increase the momentum of the thus generated snow particles. This is for example especially advantageous in case of relatively high operating currents of the cutting torch 100, but also in case of low currents. By means of increasing the momentum or speed of the CO₂-snow particles, the flow field around arc 160 and cutting torch 100 can be effectively improved. The type of carrier gas used may be a function of the material of the work piece being cut. The ejected CO₂-snow together with the carrier gas thus forms curtain flow 250a around cutting torch 100 in an effective manner.

According to the embodiment as shown in FIG. 1, the curtain flow 250a is directed onto the work piece 130 in a direction parallel to the main extension direction of plasma arc 160. This is, for example, achievable by providing a nozzle or nozzles within outlet port 230, through which the curtain flow is ejected, with a corresponding orientation.

As schematically shown in FIG. 3, outlet port 230 can for example be provided with a continuous annular gap or nozzle 230a, or a multitude of discrete nozzles or jets 230b arranged in a circle, for example around an inner or outer circumference of annular member 230. To achieve the ejection direction for curtain flow 250a shown in FIG. 1, these nozzles are orientated such that, in the view of FIG. 3, the curtain flow is ejected perpendicularly to the plane of projection.

Alternatively, if the CO₂ feed is introduced into annular member 220 without a carrier gas, the CO₂-snow may be ejected without such a carrier gas through outlet port 230, such that the CO₂-snow falls freely, for example due to a pressure within annular member 200 and gravitation, around the arc and cutting torch 100.

FIG. 2 shows a second preferred embodiment of the device according to the invention. All corresponding components are designated using the same reference numerals, so only the differences over the embodiment of FIG. 1 will be discussed in the following. The only difference is that according to the embodiment as shown in FIG. 2, the curtain flow (designated 250 b in FIG. 2) is ejected from outlet port 230 of annular member 200 in a direction forming a converging angle relative to the main extension direction of plasma arc 160. To achieve such a converging angle, it is, for example, possible to provide the nozzles 230a, 230b as shown in FIG. 3 with a corresponding orientation, i.e. in a converging manner relative to a central axis 230c extending perpendicularly to the plane of projection (not preferred as it will excessively disturb the main plasma arc flow and the shield gas flow ejected from paths 112 and path 114 respectively). It is also possible to provide the shielding flow in a direction forming a diverging angle relative to the main extension direction of arc 160, although this variant is not explicitly shown in the figures.

Providing the curtain flow 250b in a converging angle relative to the main extension direction of the plasma arc can improve the effectiveness of protection and cooling especially in cases of higher arc currents. At higher currents, the plasma arc is less susceptible to an impinging effect of the CO₂-snow, so that a slightly converging angle can provide better protection and cooling without degrading the plasma arc.

Advantageous settings are for example that the curtain flow comprising CO₂-snow is directed in a direction forming a converging or diverging angle relative to the main extension direction of the plasma arc of 5, 10, 15, 20, 25 or 30 degrees, or in a range from 5 to 30, 5 to 20, 5 to 15, 10 to 15, 10 to 20 or 20-30 degrees. Larger, smaller or any intermediate angles are also possible.

The method as described, using CO₂-snow provided by an annular member of muffler surrounding a cutting torch, as a curtain fluid, may be used during cutting of various materials, especially, but not limited to, mild steel or carbon steel, stainless steel, aluminum, copper, titanium, brass etc.

At higher currents and in case of cutting thicker materials, more fumes, noise and UV light are typically generated. Thus, the amount of CO₂-snow advantageously provided increases with the current of the plasma arc. Advantageously, the CO₂-snow flow rate is set as a function of the plasma cutting torch current.

In a preferred embodiment, the following combinations of CO₂-snow and carrier gas may be considered advantageous, for example for carbon steel cutting: oxygen plasma in combination with CO₂-snow as curtain fluid and an oxygen gas as carrier gas, or oxygen plasma in combination with CO₂-snow as curtain fluid and air as carrier gas.

For stainless steel or aluminum, and also for certain non-ferrous materials: nitrogen plasma can be used in combination with CO₂-snow as curtain fluid and nitrogen gas as carrier gas, or Ar—H₂ mixture (example: 35% H₂ with the balance argon, often referred to as H35) plasma in combination with CO₂-snow as curtain fluid and nitrogen gas as carrier gas, or Ar—H₂ mixture (example H35) plasma in combination with CO₂-snow and Ar—H₂ gas mixture as carrier gas, or Ar—H₂ and N₂ plasma (with various mix ratios) in combination with CO₂-snow as shielding fluid and nitrogen gas as carrier gas, or Ar—H₂ and N₂ plasma (with various mix ratios) in combination with CO₂-snow and Ar—H₂+N₂ gas mixture as carrier gas, or an N₂—H₂ mixture (example: F5) as plasma in combination with CO₂-snow as shielding fluid and nitrogen gas as carrier gas.

Especially, the following combinations of plasma gas/shield flow/curtain flow are advantageous in case of cutting mild steel: O2/O2/CO₂-snow, O2/O2/CO2-snow+air, O2/O2/CO2-snow+any carrier gas, air/air/CO2-snow+any carrier gas.

It is also possible to use the following combination: O2/CO2-snow+O2/CO2-snow+any gas. Here, the shield flow (i. e. the flow surrounding the plasma arc) as well as the curtain flow (i. e. the flow surrounding the shield flow) both contain CO2-snow together with an appropriate carrier gas.

The ratios between CO₂-snow and the carrier gas flow are advantageously related in such a way that the carrier gas flow rate is set at 0.5 of the CO₂-snow flow rate, or is set to match the CO₂-snow flow rate, or is set at 1.5 times or twice the CO₂-snow flow rate, or is set at 5 times the CO₂-snow flow rate, or is set at ten or 15 times the CO₂-snow flow rate. Intermediate or higher ratios are also possible.

However, in a simple and thus easy to handle implementation, an expedient CO₂ flow rate for annular member 200 is used for all current and cutting torch shield gas flow settings of cutting torch 100.

Be it noted that is also possible to provide annular member 200 with CO₂-snow from an external source. In this case, for example, means for expanding CO₂ feed within annular member 200 can be omitted. Such a simplified annular member or muffler can be provided with a carrier gas feed, if desired.

All embodiments as shown can help to minimize or eliminate drawbacks experienced in prior art plasma cutting. Once fume particles generated during plasma cutting are condensed from the gaseous phase due to the low temperatures of the CO₂-snow applied and also providing nucleation sites, metal and oxide particles are carried towards the work piece and collected. As the CO₂-snow warms up, it changes phase from solid to gas (i.e. it sublimes), so that no waste liquid remains, which would have to be collected and disposed of. The CO₂-snow also acts as a barrier that can capture metal and metal oxide particles generated during cutting.

The added cooling provided by this CO₂-snow ejected from annular member 200 improves survivability of the cutting torch as a whole. Using a device according to the invention, there is no need to use water tables and under water cutting, thus improving cutting quality and speed. Both noise levels and light emissions are reduced resulting in an improved working environment for an operator.

In order to further optimise a highly constricted plasma arc 160 for plasma cutting, it is additionally possible to use CO₂-snow as a shielding flow passing through passage 114 of the actual cutting torch 100. This CO₂-snow acts as a constricting flow (gas-solid mixture, i.e. a two phase flow) for cooling the fringes of arc 160. As the fringes of the plasma arc cool down, the arc diameter decreases, causing an increase in the core temperature of the plasma. This results in an increase in electrical conductivity of the plasma arc 160, thereby allowing conduction of the same current through a reduced cross sectional area of the plasma arc. This increase in arc constriction improves the piercing capacity, cutting speed and cutting quality achievable with plasma arc 160. This improves the constriction in traditional shield gas flows. It also eliminates the draw backs of liquid water injection due to the sublimation of the CO₂-snow.

The CO₂-snow may be injected without any further carrier gas through passage 114. In a preferred embodiment, however, CO₂-snow is injected together with a carrier gas, such as nitrogen, oxygen, air, argon, etc. or a mixture thereof.

The CO₂-snow thus ejected around the plasma arc 160 acts also as a curtain to immediately cool, condense and nucleate any metallic fume generated on the work piece 130 into particulates, preventing an uncollected escape. Furthermore, it effectively reduces noise levels generated by the process by acting as a damping barrier to the noise generated by the plasma arc. Also, it absorbs UV radiation generated in the process and prevents the formation of ozone further away from the arc zone along the radiation path. CO₂-snow provided through passage 114 acting as a shielding flow also cools the outside of the torch during cutting or piercing of thick material work pieces and during higher current operation, whereby the life of a plasma cutting torch and its consumables, especially nozzle, and shield etc. can be increased. Also, it effectively cools thinner work pieces such as thin plates, thereby reducing warpage and thus eliminating complex procedures of nesting various cutting paths across the length and width of the work piece, which, in prior art applications, can increase cutting time and reduce the process throughput.

1. Device for plasma cutting a work piece, comprising a cutting torch (100) configured and adapted to generate a plasma arc between itself and the workpiece, the cutting tool being provided with an electrode (120), which is coaxially surrounded by a nozzle (110), thereby defining a passage (112) for passing of a plasma gas between electrode and nozzle, wherein the nozzle is coaxially surrounded by a shielding cap (122), thereby defining a passage (114) for passing of a shielding flow between nozzle and shielding cap, the device further comprising an annular member (200) coaxially surrounding the cutting torch (100) configured and adapted to provide a further curtain flow coaxially surrounding the shielding flow through passage (114) between nozzle and shielding cap (122) wherein annular member (200) is configured and adapted for use of CO₂-snow or a mixture containing CO₂-snow as shielding flow.

2. Device according to claim 1, wherein passage (114) is configured and adapted for use of CO₂-snow or a mixture containing CO₂-snow as shielding flow.

3. Device according to claim 1, wherein the annular member (200) is configured and adapted to be provided with CO₂-snow and to form the curtain flow using this provided CO₂-snow.

4. Device according to claim 1, wherein the annular member is configured and adapted to be provided with liquid CO₂, generate CO₂-snow on the basis of this provided liquid CO₂, and form the curtain flow using the generated CO₂-snow.

5. Device according to claim 1, wherein the annular member (200) is configured and adapted to provide a shielding flow comprising CO₂-snow with or without a carrier gas.

6. Device according to claim 1, wherein the annular member (200) is configured and adapted to provide a curtain flow which is directed in a direction forming a converging or a diverging angle relative to a main extension direction of the plasma arc generated between the cutting torch and the work piece.

7. Device according to claim 1, wherein the annular member (200) is configured and adapted to provide a curtain flow which is directed in a direction parallel or essentially parallel to a main extension direction of the plasma arc generated between the cutting torch and the work piece.

8. Device according to claim 1, wherein the annular member (200) is configured and adapted to provide a curtain flow in a direction perpendicular or essentially perpendicular to a main extension direction of the plasma arc generated between the cutting torch and the work piece.

9. Device according to claim 1, wherein the annular member (200) is configured and adapted to provide a curtain flow with a rotational component defining a rotational movement about a main extension direction of the plasma arc generated between the cutting torch and the work piece.

10. Device according to claim 1, wherein the annular member (200) is configured and adapted to provide the curtain flow as a continuous annular curtain.

11. Device according to claim 1, wherein the annular member (200) is configured and adapted to provide the curtain flow in form of a set of annularly arranged jets provided around the circumference of the annular member.

12. Method for plasma cutting a work piece, comprising the following steps:
providing a cutting torch configured and adapted to generate a plasma arc between itself and the work piece,
providing a shielding flow to coaxially surrounding the plasma arc, and
providing a curtain flow coaxially surrounding the shielding flow, wherein the curtain flow comprises CO2-snow or a mixture containing CO2-snow.

13. Method according to claim 12, wherein an annular member (200) is provided to provide the curtain flow, the annular member being configured and adapted for use of CO2-snow or a mixture containing CO2-snow as shielding flow.
